(19) United States
(12) Patent Application Publication
(10) Pub. No.: US 2004/0177149 A1
(43) Pub. Date: Sep. 9, 2004

(54) System and method for presentation at the election of a user of media event information and further media event information of media events all related to a preselected time period

(76) Inventors: Paul F. Zullo, Pound Ridge, NY (US); Isaac Morales De Leon, Gibson, NY (US)

Correspondence Address: ROBIN BLECKER & DALEY, 2ND FLOOR, 330 MADISON AVENUE, NEW YORK, NY, 10017, US

(21) Appl. No.: 10/382,324

(22) Filed: Mar. 5, 2003

(51) Int. Cl. G06F 15/16

(52) U.S. Cl. 709/228

(57) ABSTRACT

A method and system is provided for the presentation at the election of a user of media event information and further media event information all related to a preselected time period. The system piques the user's interest in the media events, which helps stimulate the user to purchase products related to the events.

A computer program listing appendix listing the computer source code referred to herein is available separately on a compact disc and a duplicate copy compact disc, each labeled in accordance with 37 CFR §1.52(e)(6), and each containing a total of six (6) files created on Mar. 4, 2003 and having the following names and sizes:

| File Name | Size (bytes) |
|---|---|
| DVD_Template.txt | 8,639 |
| DVD_Template_ads.txt | 10,130 |
| Music_Template.txt | 10,241 |
| Music_Template_ads_new.txt | 13,157 |
| Start.txt | 5,436 |
| year.txt | 301 |

The computer program listing appendix on each of the two (2) compact discs is incorporated as part of the present disclosure.

### BACKGROUND OF THE INVENTION

This invention is directed to a system and method for providing media event information that enables a user to make selections of the media events to obtain further information about, or preview products relating to, the events. More particularly, the invention is directed to a system and method in which a storage unit, a processing unit and an interactive interface cooperate to facilitate user selection of a media event having audio, audio-visual and textual components, to present the selected media event, and to enable the user to obtain further information and products relating to the selected media event upon user demand.

It is well known that information about almost any topic is readily available in many forms, for example, through television programs, books, cassettes, magazines, on CD-ROM and perhaps most commonly on the Internet. Magazines and similar kinds of printed materials for education or entertainment provide content relating to a specific subject and may mention and/or offer specific products available with respect to that subject, but do not enable the reader at the time of reading the magazine to experience or use the product so that the reader can then better decide whether to receive or purchase the product. Other forms of conventional media such as TV programs, books, cassettes and pre-recorded CD-ROMs have similar limitations.

More particularly, conventional media, as above-mentioned, do not permit the reader to experience the subject matter in any form other than that in which it is presented. In other words, a magazine article about a specific musical performance or group may give textual information and visual images that inform and entertain the reader, but it cannot give the reader a sense of what the performance or group actually sounds like. The ability to preview, in audio, video or textual form (or a combination thereof), media events or products relating to a selected topic is particularly appealing with respect to books, music and video. For example, a music enthusiast would rather hear a clip of music than be limited to textual and visual materials describing the music. Similarly, it is most preferable to an interested user after being given background information about, for example, a writer, producer, director or subject matter, to read an excerpt from a book, or to view a movie trailer related thereto, in order to experience the writer, producer, director or subject matter.

It has been noted, and a psychological explanation likely exists for the fact that hearing certain sounds, particularly music, seeing images or both can evoke an emotional response and stimulate recall of memories. From a marketing standpoint, such a response engages the user in a multimedia presentation having audio and visual components and generates more interest in the subject matter to which the presentation relates. Even in the absence of an emotional response, an audiovisual preview enables a reader of textual material about the audiovisual material to further understand the material and to ascertain whether he or she enjoys or is interested in it. For example, the experience of reading about a particular genre or group of music that a person knows little or nothing about is greatly enhanced by the ability to preview the music to decide whether he or she actually likes the music. Ultimately, a reader of textual material on a subject relating to books, music and/or video who is able to select and preview a book, music or video contemporaneously with obtaining further information relating to his selection is very likely to be interested in previewing other books, music or videos relating to his selection, in obtaining further information regarding his selection, or even in purchasing the book, music or video selection that he has made.

Technology has evolved which has attempted to overcome the above limitations of conventional printed media and to meet the demands of information-hungry consumers. Information is now most commonly or at least most easily obtained on the Internet using a search engine, or by purchasing or downloading interactive software with comprehensive information including links to further information or related products. Interactive programs with audiovisual components are popular for educational purposes, such as learning a difficult language, and serve to illuminate the subject matter and make the learning process more entertaining. Such Web sites and interactive software also enable a user to tailor the content and duration of his or her educational experience according to corresponding interests and skill level.

Audiovisual presentations on CD-ROM or similar digital media, such as compilations of musical works, typically include audio and video events relating to the subject matter of the presentation as well as textual material that joins the audiovisual components of the presentation together in a contextual background (e.g., the history of jazz music). Such compilations in digital form permit the user to navigate through various audio and visual events but do not provide a mechanism to preview or probe deeper into the events. A common example is a compact disk set that may be purchased in exchange for the buyer's right to listen to the selected works (and view corresponding visual materials) in their entirety. Without the ability to preview and probe deeper into the audiovisual materials, however, a buyer will not discover until after purchasing and viewing the presentation whether the materials are suited to his interests and tastes.

Other examples are online encyclopedias (such as on the Encyclopaedia Britannica (“EB”) web site, located at http://search.britannica.com/) and informational Web sites (such as the Human Genome Research Institute (“HGRI”) site, located at http://www.genome.gov) that offer volumes of information joined together by a timeline or categorized in a table of contents, from which a user may select specific portions of the timeline or certain events in a list to obtain further information of interest to the user. U.S. Pat. No. 5,241,671 owned by Encyclopaedia Britannica, Inc. describes a multimedia search system including a database with text, picture, audio and animated data, which is searchable by a plurality of graphical and textual entry paths including a history timeline. In using the timeline, the user is presented with a first display having major event boxes each covering a number of events in a given category and event boxes each covering a single event of historical significance occurring in the selected period of the timeline. The user can select a major event box which will result in the user being presented with a second display listing single events from which the user can then select a specific event to obtain further information about the event. The user may alternatively select from the first display an event box which will result in information about the specific event being presented to the user. An audio feature is also available to supplement information about an historical event.

In the EB and HGRI Internet sites mentioned above, a timeline may be used in conjunction with images, video and other multimedia components that supplement prewritten text to further engage the user in the educational presentation and materials. In the EB site, the timeline is an historical timeline, as in the '671 patent, having different categories of historical information which can be selected by the user. One of the categories is music. Selection of the music category and a time period on the timeline results in the display of written text about a specific historical event relating to music in the period, with smaller text on opposite sides of the display of written text relating to the previous and next musical historical events. In the HGRI site, the timeline covers the development of human genome research. Selection of a year provides a display of a specific event in the chronology of events relating to such research, and provides the user with the ability to select more information relating to that event.

U.S. Pat. No. 5,963,916 owned by Intouch Group, Inc. describes a point-of-preview music kiosk or “listening booth” by which a user may access a network web site to select and preview pre-selected portions of music products. In this system, music categories of various types are used as a mechanism for searching for music products.

U.S. Pat. No. 5,524,195 owned by Sun Microsystems, Inc. describes a similar interactive system for selecting video programs. In a preferred embodiment, a graphical user interface includes a series of posters corresponding to programs available for selection by the user. A user may view more details about the program on the poster itself, or select an “extra” by which he may receive further information about the program. By selecting the poster image again the user may preview the program and order delivery of an entire program on demand.

U.S. Pat. No. 6,314,575 owned by Time Warner Entertainment Company, L.P. teaches a telecasting service that offers video programs on user demand and includes an interactive interface which enables the user to scan and preview available programs. The system taught by this patent also facilitates user selection of video programs by organizing the programs into a menu and providing images, segment previews, and textual information about each program. The interactive interface thus allows a viewer to readily obtain information in various forms with respect to any available program.

It is therefore an object of the present invention to provide a system and method for the presentation of media events including audio, visual and textual information that facilitates user selection of further information about the events so as to promote the preview of products relating to the events.

### SUMMARY OF THE INVENTION

In accordance with the principles of the present invention, there is provided a system and method for the presentation of media events in which a storage unit or assembly for storing the media events, a processing unit and a user interface cooperate to present to a user media event information for specific media events all related to a preselected time period, to enable the user to select the media event information for a given one of the media events, and to present to the user further information regarding the event. In the illustrative form of the invention disclosed hereinbelow, the user is enabled to select a preselected time period from a plurality of preselected time periods, contextual material is provided to the user after selection of a preselected time period, and the presentation of the media events includes presenting calendar months for the preselected time period which include therethrough the media events.

### BRIEF DESCRIPTION OF THE DRAWINGS

The above and other features and aspects of the present invention will become more apparent upon reading the following detailed description in conjunction with the accompanying drawings, in which:

FIG. 1 is an illustration of the apparatus for implementing the system and method of the present invention;

FIGS. 2A-2C are flow charts depicting the method steps of the present invention;

FIG. 3 is an illustration of an introduction frame of the method of the present invention;

FIG. 4 is an illustration of a calendar frame in accordance with the present invention;

FIG. 5 is an illustration of a frame providing a closer look at a segment of the calendar frame of FIG. 4;

FIG. 6 is an illustration of the time period control according to the present invention;

FIG. 7A is an illustration of a frame displaying a grouping of music-related media events in accordance with the present invention;

FIG. 7B is an illustration of a frame displaying a grouping of film-related media events;

FIGS. 8A and 8B are illustrations of first and second frames of a two-frame grouping of film-related media events;

FIG. 9 is an illustration of a close-up frame displaying further media event information relating to a music-related media event selected by the user;

FIG. 9A is an illustration of a close-up frame displaying the media player provided in connection with the further media event information relating to the music-related media event selected by the user as illustrated in FIG. 9;

FIG. 10 is an illustration of a close-up frame displaying further media event information relating to a film-related media event selected by the user; and

FIG. 10A is an illustration of a close-up frame displaying the film trailer control provided in connection with the further media event information relating to the film-related media event selected by the user as illustrated in FIG. 10.

### DETAILED DESCRIPTION

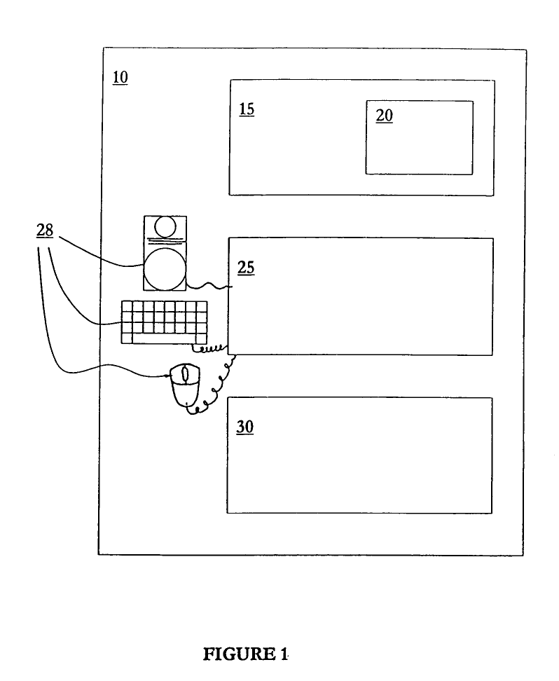

FIG. 1 illustrates a system for presenting media event information to a user in accordance with the present invention. The system includes a storage unit or assembly, processing unit and interactive interface that work together to provide a presentation to the user of media event information relating to specific media events. As used herein, “media events” refers to books, magazines, music and other sound recordings, films, theater productions, video recordings and other forms of entertainment material or the like which are associated with a specific time period, either by the date the material was created, authored, released, or even the time period in which the event takes place. The system components work together to present contextual material, including audio and video components and still images of the media events, as well as textual material relating to the events, to the user and enable the user to select a media event from a plurality of media events and obtain further information including contextual material regarding the selected media event.

As shown in FIG. 1, the system 10 includes a storage unit or assembly 15 for storing data 20 relating to the presentation of media event information, a central processing unit 25 and an interactive interface 30 for providing the presentation of the information to the user and enabling the user to interact with it. In one embodiment, the storage unit or assembly 15 may comprise a data storage unit such as a CD-ROM or DVD. In another embodiment, the storage unit or assembly 15 may comprise a server or hard drive that provides access to the data 20 relating to the presentation of the media event information via a global computer network such as the Internet. In yet another embodiment, the data 20 stored in the storage means 15 is accessible to the user via cable or broadband and is presented to the user on a television or similar visual device.

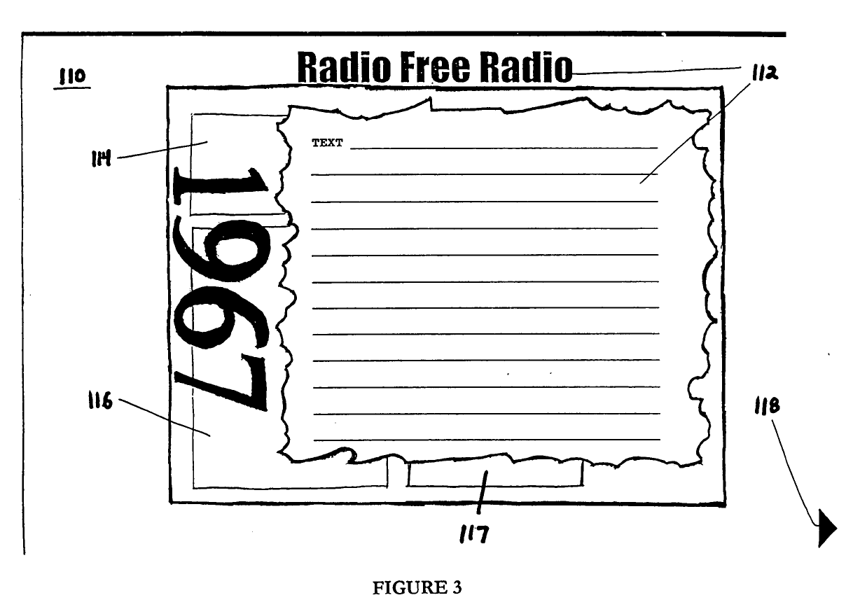

The storage unit or assembly 15 stores data files 20 used in connection with the method and system of the present invention. Particularly, the storage unit or assembly 15 stores data files with textual, video and audio components of the contextual material that is provided to the user as explained further below with respect to FIGS. 3 through 10A. The storage unit or assembly 15 also stores data files with the video and audio portions of preselected media events and data files for storing still images and any additional data associated with the media events. The still image data, video and audio portions of the media events are preferably stored in a compressed format in the storage unit or assembly 15. Various other available storage media and systems may also be used in accordance with the method of the present invention.

The central processing unit 25 is coupled to the storage unit or assembly 15 and is preferably a multiple processor computer system that is capable of processing requests from the user for data and text stored in the data files and obtaining such files from the storage unit or assembly for presentation to the user on the interactive interface, as explained in further detail below. In a preferred embodiment, the processing unit 25 is a computer equipped with a high speed processor, or a network of computers with processors operating in parallel, to provide adequate processing capability to accommodate processing requests from the user and to otherwise perform the method of the present invention. The processing unit 25 may also include input/output devices 28, such as a keyboard, mouse and speakers, all of which are considered peripheral components of the processing unit 25. The central processing unit 25 is also coupled to an interactive interface 30, which has a display monitor, television monitor, computer screen, or other visual display device.

The interactive interface 30 shown in FIG. 1 is adapted to present to the user media event information including contextual material relating to preselected media events. Such contextual material includes audio, visual and textual components as well as still images. As shown in greater detail in FIGS. 3 through 10A, contextual material is displayed to the user on the display of the interface 30. The interface 30 enables the user to select media event information of a given one of the one or more specific media events. The user may select specific media event information using the interactive interface 30, as described in greater detail below, and any peripheral component 28 of the processing unit 25, such as a mouse or keyboard, or by using a touch-screen, or by a remote control or any other selection device or program presently known in the art.

In general, when the user selects a media event from a plurality of media events displayed on the interactive interface 30, the central processing unit 25 retrieves text and data files corresponding to the selected media event from the storage unit or assembly 15 and presents video and audio data relating to the event, as well as corresponding text, to the user at the interactive interface. Subsequent selections made by the user with respect to the selected media event, other media events, or any other portions of the presentation are similarly processed.

It should also be noted that the method and system of the invention contemplate that the storage unit or assembly 15, the processing unit 25 and interactive interface 30 may be included in a single station or kiosk available to the user. These components can also be distributed among various locations, with the location of the interface 30 being available to the user, while the locations of the storage unit or assembly 15 and processing unit may be remote from the user and also remote from each other.

Thus, for example, it is within the contemplation of the invention that the interface 30 be the display of a personal computer and that the storage unit or assembly 15 and processing unit 25 be situated at remote locations or on file servers accessible via a communication network including the Internet. Another alternative is that the interface 30 be part of or incorporated into a television display which can be operated by remote control by a user, and that the storage unit or assembly 15 and processing unit 25 be incorporated into a broadband television system and, in particular, a broadband cable television system.

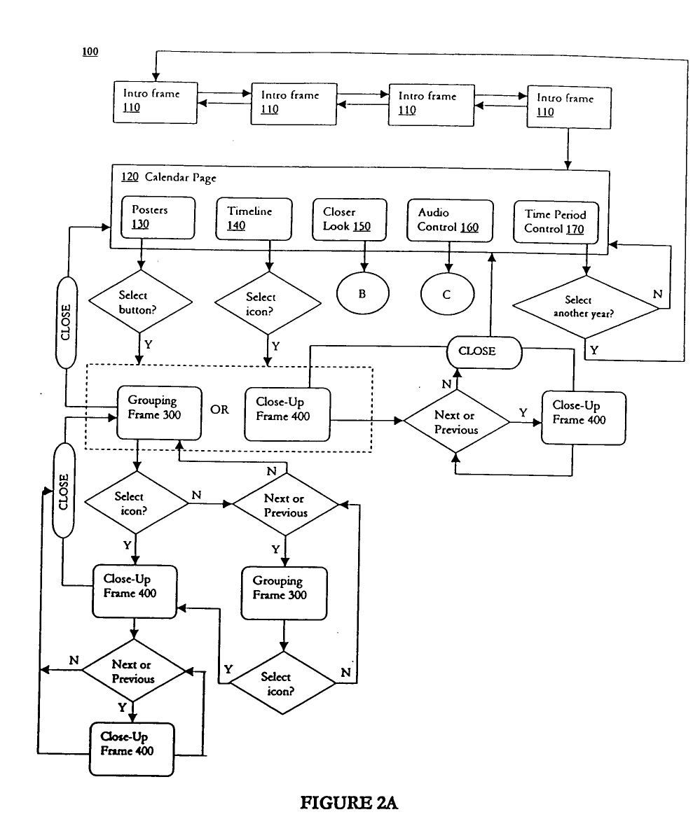

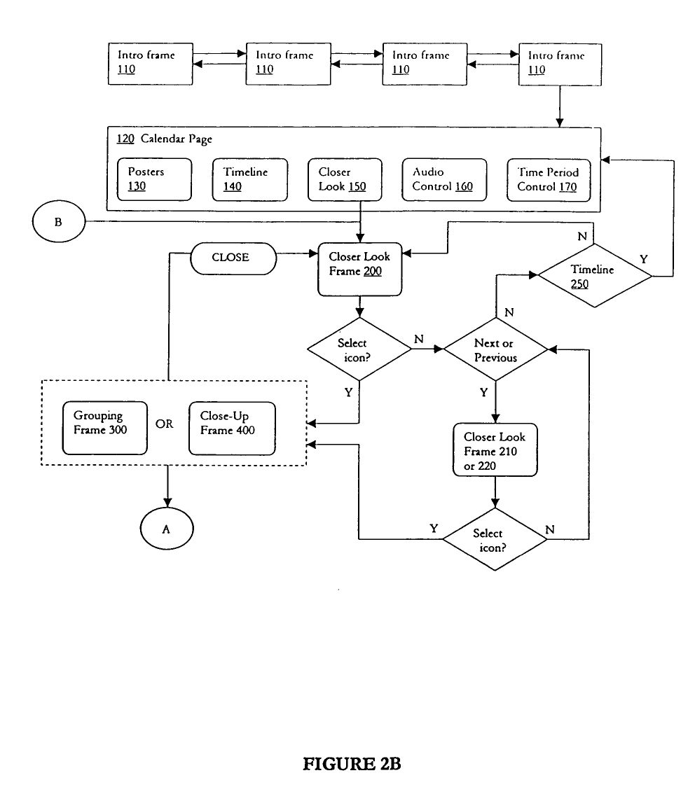

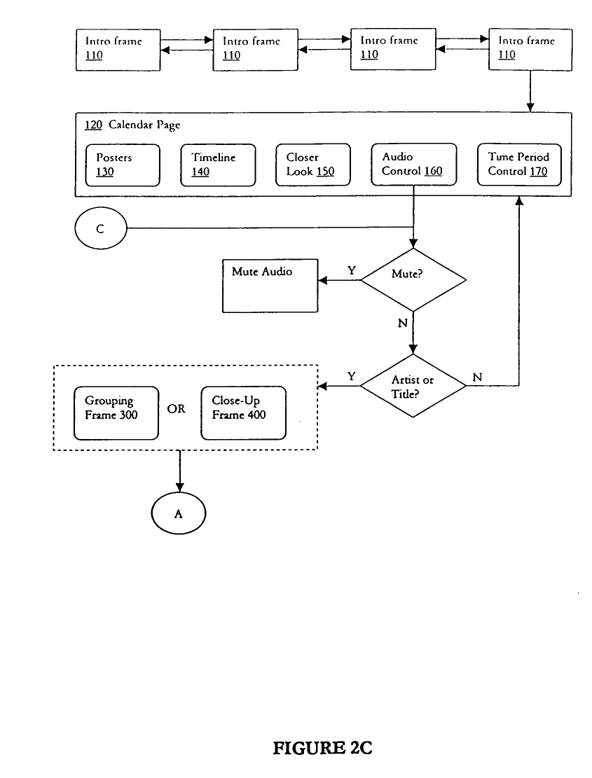

FIGS. 2A-2C are flow charts depicting the method steps 100 of the present invention from the perspective of what is displayed on the display device of the interactive interface 30. In each step, audio, video and/or textual components of media events are presented to the user and usually include the option to obtain further media event information or products relating to any of the media events.

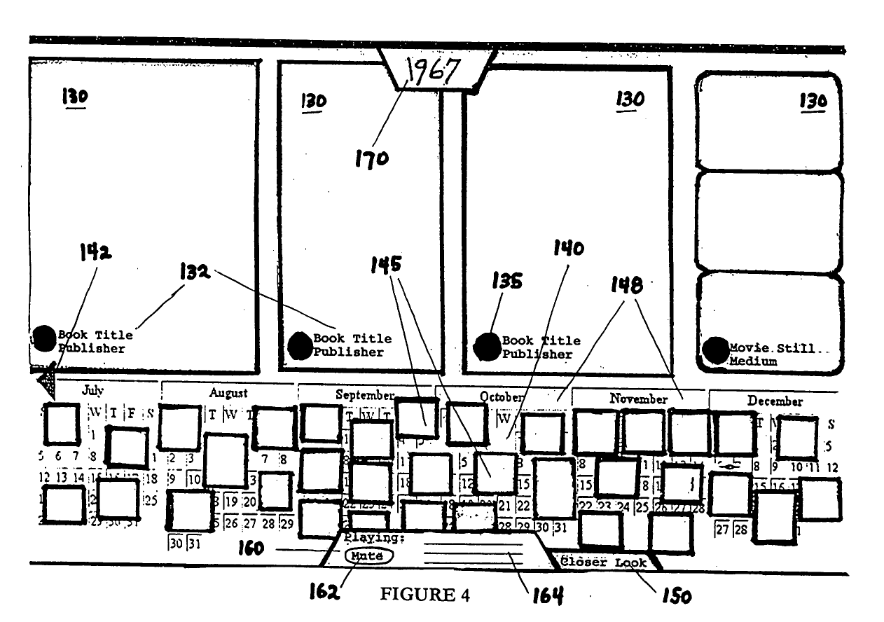

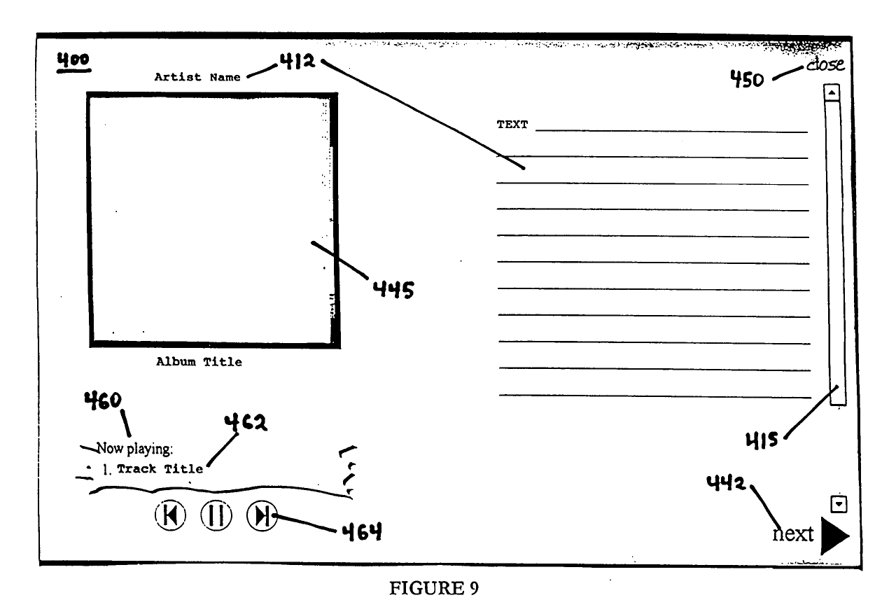

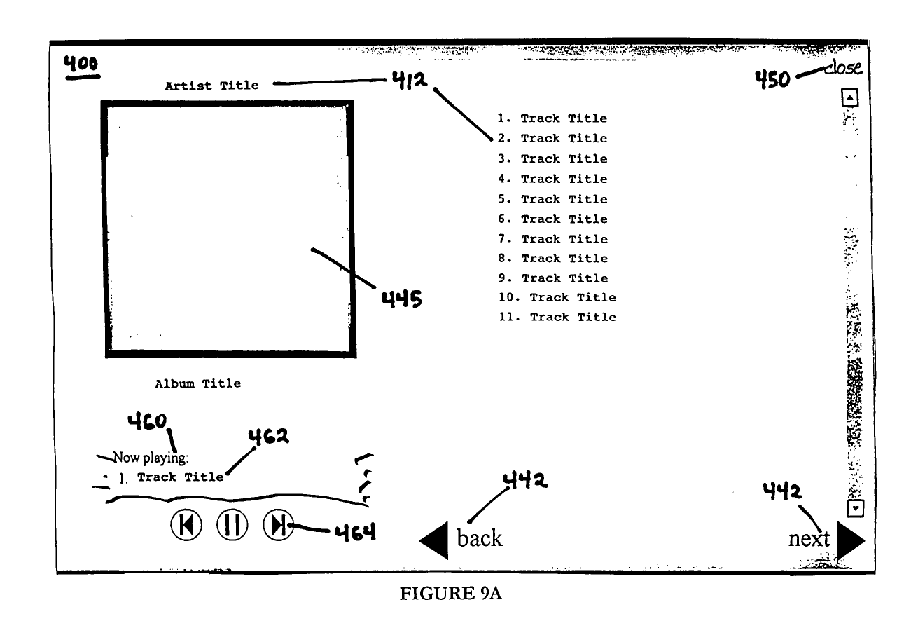

In the illustrative embodiment, audio components of preselected media events relating to the time period selected by the user are continuously provided to the user. As further described below with respect to FIGS. 4 and 9, the preselected segments of audio are presented in random order before the user selects further media event information relating to one event. Once the user has selected further information relating to a media event, the audio segments relate specifically to the selected media event. In either situation, the user always has the option to “mute” the audio component of the presentation at any time during the presentation.

Introductory Frames

As shown in FIG. 2A, when the presentation begins, an introductory frame containing contextual material related to the media events for a preselected period of time is presented to the user. FIG. 3 is an illustration of one embodiment of an introductory frame 110. The contextual material presented in the introductory frame may include textual material 112, images 114, graphics 116 and video 117 all relating to media events occurring in the preselected period of time. The contextual material also includes the background audio component and puts the media events in context for the user in the preselected period of time. Such introductory frames 110 may be continued on additional frames that can be accessed by the user by selecting an icon such as a forward arrow 118, as shown in FIG. 3. Additional introductory frames have the same or a similar configuration as the frame shown in FIG. 3 and may also feature a reverse arrow icon to enable the user to return to the previous introductory page if he chooses.

After the introductory contextual material regarding the media events in a preselected period of time has been presented to the user in the introductory frames 110 as described above, the next selection of the forward icon 118 by the user provides the user with a presentation of a calendar frame 120. One embodiment of the calendar frame 120 is shown in FIG. 4. The calendar frame 120 initially presented to the user corresponds to certain number of sub-periods of the preselected period of time. As can be appreciated, the initial number of presented sub-periods is limited by the display size. As will be described in greater detail below, the user subsequently may choose to view the remaining sub-periods by scrolling the initial calendar frame, or may choose to view a particular grouping of sub-periods in enlarged format, for the selected time period according to the method of the present invention. Each calendar frame 120 combines posters 130 with buttons 135, a timeline 140 of sub-periods 148 with image icons 145, a closer look button 150, an audio control 160 and a time period control 170 to facilitate the user's selection of media event information.

Posters/Images

Posters 130 are large images representing media events occurring during the preselected time period. Posters 130 may be movie posters, advertisements of Broadway plays, album covers, book covers, photographs of musicians, actors, or other media celebrities, graphical works such as cartoons or drawings relating to one specific event, images of movie stills, or any other visual representation of a specific media event within the preselected time period. Textual material 132 identifying the poster and the corresponding media event may be superimposed on the poster 130. Visual buttons 135 are provided on each poster 130 and may be selected by a user using a peripheral device 28, touch screen display, remote control, or similar means as described above to obtain further information about the media event represented by the poster. Turning back to FIG. 2A, upon selecting a button 135, the user is then presented with either a grouping frame 300 or a close-up frame 400, each of which will be described in detail below.

Timeline/Calendar

The calendar frame 120 also displays a timeline 140 of sub-periods 148 of the preselected time period. In the embodiment shown in FIG. 4, the preselected time period is one year and the sub-periods 148 of the timeline 140 are individual months of the calendar year. In order to provide all the months of the year on the calendar frame 120, the timeline 140 has a scrolling feature that may be enabled by the user selecting either a forward or back arrow icon 142. In the illustrative embodiment, by selecting an arrow icon 142, the timeline scrolls horizontally in either direction to display months of the calendar year either later or earlier than those originally displayed. The user may scroll to the beginning and end of the timeline, which are the first and last months of the preselected calendar year in the embodiment shown in FIG. 4. As the user selects an arrow 142 to scroll forward or backward in a timeline 140, the calendar frame 120 may also feature automatic scrolling of the posters 130 parallel to the timeline 140 and at the same speed or a slightly faster or slower speed than the timeline 140, so that additional posters 130 may be displayed on the calendar frame 120 in connection with the preselected time period.

In the illustrative embodiment, image icons 145 appear on each month of the year in the timeline 140. More particularly, like the posters 130, each image icon 145 may be an image of a movie poster, Broadway play advertisement, album cover, book cover, photograph of musicians, actors, or other media celebrities, graphical work such as a cartoon or drawing relating to one specific event, image of a movie still, or any other visual representation of a specific media event within the preselected time period. The image icons 145 are smaller in size than the posters 130, such that several icons 145 may be disposed on each month of the timeline 140 close to the date associated with that event. Examples of relevant media event dates include the release date of a musical work or film, opening date of a Broadway play, publication date of a book, or the approximate date on which a book, movie, play or other event takes place. Functionally, however, the image icons 145 have more in common with poster buttons 135 in that by selecting an icon 145 using a peripheral device 28, touch screen display, remote control, or similar means as described above, a user may obtain further information about the media event represented by the icon. More particularly, as shown in the flow diagram of FIG. 2A, upon selecting an image icon 145, the user is provided with a presentation of either a grouping frame 300 or a close-up frame 400, each of which will be described in detail below.

Closer Look

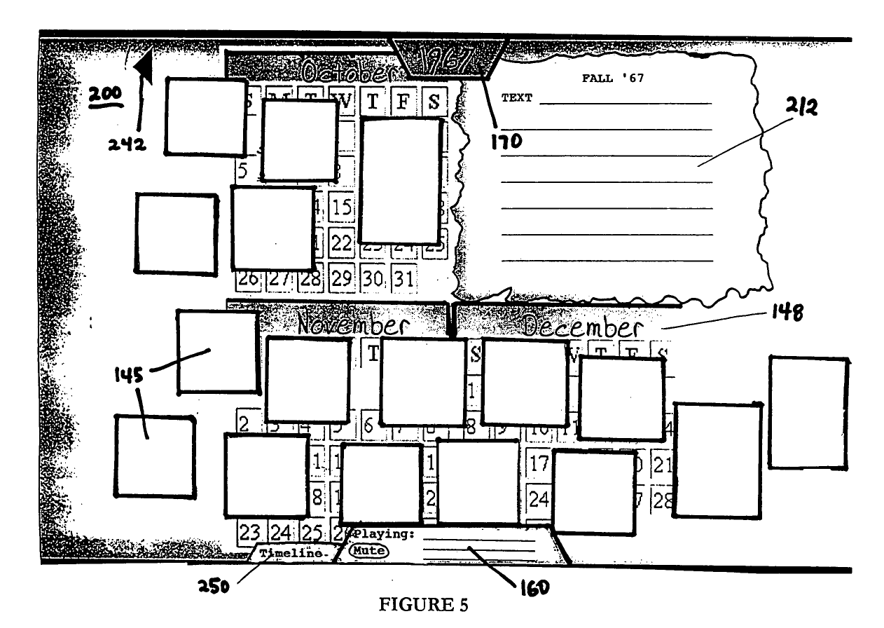

At any time while the user is viewing the calendar frame 120, he may wish to select a segment or grouping of the sub-periods of the timeline 140 for a closer look in order to facilitate his selection of an image icon 145 within that segment of time. By selecting the “closer look” button 150 on the calendar frame 120 shown in FIG. 4, the user is then presented with a closer look frame 200, which is illustrated in FIG. 5.

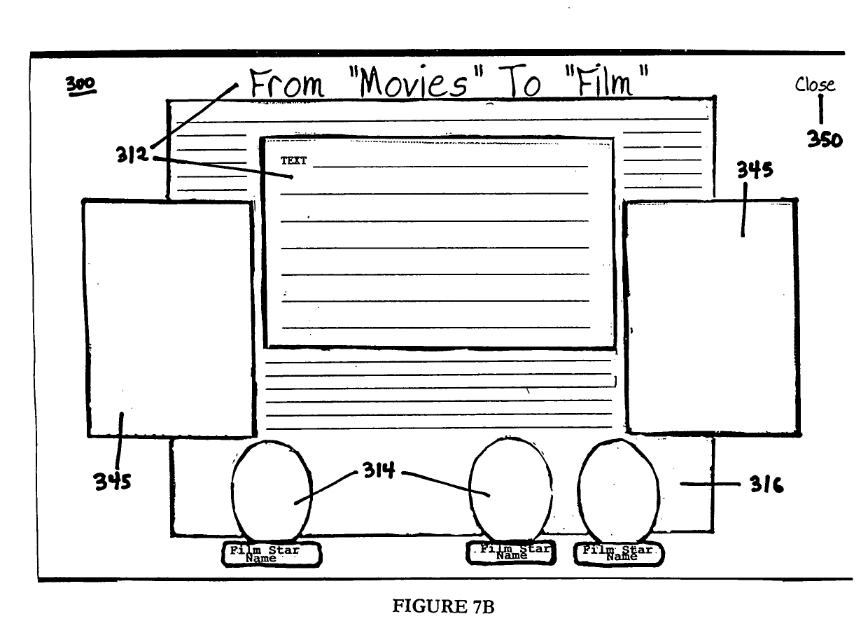

Turning to FIG. 5, the closer look frame 200 provides further media event information to the user relating to the selected segment of the preselected period of time. Particularly, in the embodiment shown in FIG. 5, the closer look frame 200 displays three sequential sub-periods 148 or months of the timeline 140 which are enlarged to fill most of the frame 200. The closer look frame 200 also displays as further contextual material, shown as written contextual material 212, regarding the three-month segment. The segment shown approximately corresponds to the user's position along the timeline 140. In the illustrative embodiment, the three months displayed on the closer look frame 200 are the last three months (“Fall”) of the selected time period. Each month in the closer look frame 200 also includes enlarged versions of the image icons 145 disposed on each of the three months in the timeline 140. By selecting an icon 145 using a peripheral device 28, touch screen display, remote control, or similar means as described above, a user may obtain further information about the media event represented by the icon. As shown in FIG. 2B, upon selecting an image icon 145 on the closer look frame 200, the user is presented with either a grouping frame 300 or a close-up frame 400, which will be described in greater detail below with respect to FIGS. 7A through 10A.

The user may navigate through the timeline by viewing the closer look frames 200 sequentially. Particularly, forward and/or back arrow icons 242 are provided on the closer look frame 200 for selection by the user to view a frame 210 corresponding to the next three-month segment of time on the timeline or a frame 210 corresponding to the previous segment (i.e., “Spring,” “Summer” or “Fall”), respectively. Like the timeline 140 on the calendar frame 120, the user may navigate to the last time segment or last month of the selected time period or year and may view segments to the first month of the selected year.

An audio control 160 is also provided on the closer look frame 200 and is operable by the user in the same manner as described in detail below with respect to the calendar frame 120 of FIG. 4.

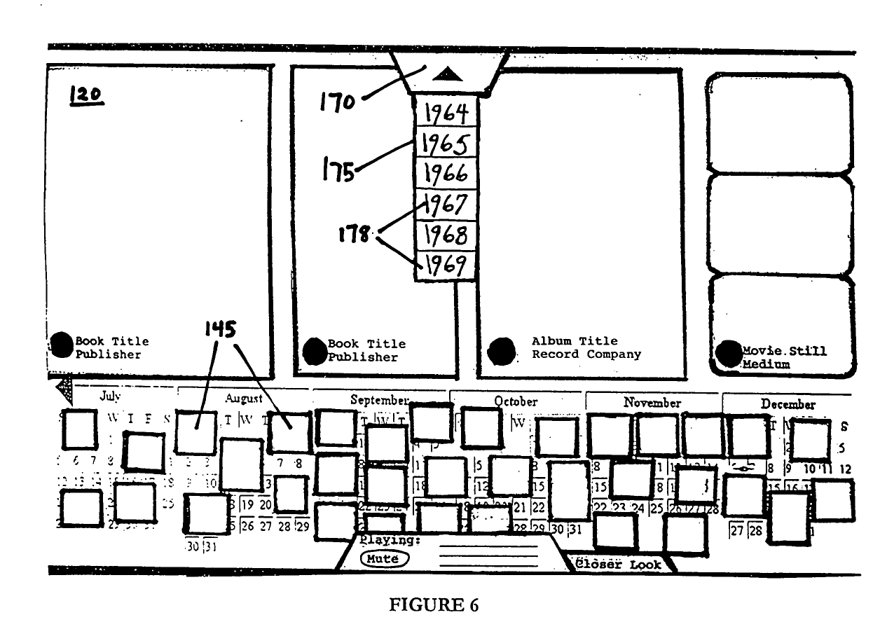

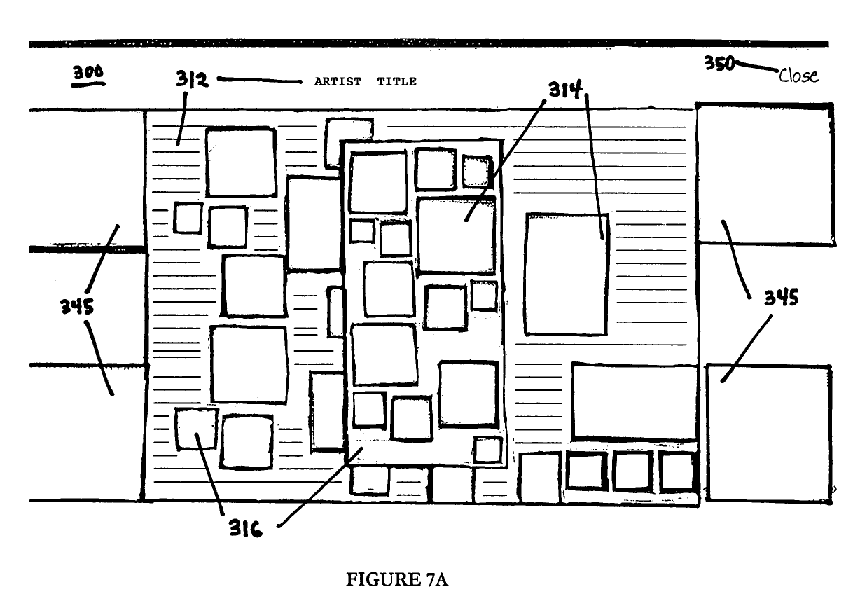

In order to exit the closer look frame 200, a user may select either a timeline button 250, which returns the user to the calendar frame 120 for the selected year, or a time period control 170, which enables the user to select another time period or year and view the timeline 140 on the calendar frame 120 for the newly selected year. The time period control 170 is described in further detail below with respect to FIG. 6.

Audio Control

As discussed above, audio components of media events relating to the time period selected by the user are continuously provided to the user during the presentation of the introduction frames 110, calendar frame 120 and closer look frame 200. More particularly, preselected segments of music or sound recordings are presented in random order during the steps before the user selects a specific media event. As shown in FIGS. 4 and 2C, a control 160 is provided for displaying information 164 relating to the audio component of the media event that is currently playing, such as artist and title of the musical work. If the user selects the artist or title of the audio component on the audio control 160, the user is presented with further information about the artist and work in the form of a close-up frame 400 described further below. In addition, at any time while the control 160 is available, the user can choose to mute the audio component of the media event by selecting the mute button 162. The audio component may be reactivated by selection of the mute button 162 a second time.

Time Period Control

The calendar frame 120 includes a time period control 170 that enables the user to select another preselected time period from a plurality of preselected time periods such as, for example, another year from a group of years. As shown in FIG. 4, the time period control 170 displays the time period corresponding to the timeline 140 on the calendar frame 120. When the time period control 170 is selected, as shown in FIG. 6, the user is presented with a drop down menu 175 of all the preselected time periods 178 available for selection by the user. In the illustrative embodiment, the preselected time periods are represented by a series of years in a decade. As shown in FIG. 2A, once a time period is selected by the user, the system displays a calendar frame 120 corresponding to the selected year, and the user may continue to interact with the system as set forth herein.

The illustrative embodiment of the calendar frame 120 shown in FIG. 4 is one example of the presentation of media events on video display of the interactive interface 30 according to the system and method of the present invention. It is understood that various other embodiments of the calendar frame 120 may be used, in which the display of posters 130 with buttons 135, monthly calendar 140 with image icons 145, time period control 150 and audio control 160 may have a different appearance, shape, size, and placement on the video display of the interactive interface 30 in accordance with the present invention. In addition, the timeline 140 and posters 130 may scroll vertically or be presented in one of various other arrangements in order to enable the user to view all segments of the preselected time period and all posters and image icons associated therewith. Also, other embodiments of the invention contemplate use of the timeline with sub-periods and image icons distributed therethrough without use of the posters and presentation of audio components of the media events.

Grouping Frames

Again referring to FIG. 2A, upon selection of either a button on a poster 130 or an image icon on the timeline 140 of the calendar frame 120, or upon selection of an image icon on the closer look frame 200 as shown in FIG. 2B, the user may be presented with a grouping frame 300. Particularly, if the user selects a media event associated with a large number of other media events in the presentation, then rather than being presented next with media event information specifically relating to the selected event, the user will first be presented with a frame 300 having contextual information relating to a preselected grouping of media events associated with the selected event.

One embodiment of a grouping frame 300 in accordance with the present invention is shown in FIG. 7A, which shows a grouping of music-related media events and corresponding contextual information, including a combination of textual material 312, images 314 and graphics 316, such as, for example, magazine articles, photographs, album covers, cassette or compact disk jackets, and identifying information about the artist or band.

The grouping frame 300 as shown in FIG. 7A also includes a plurality of image icons 345, each of which, like image icons 145 on the calendar frame 120, represents a media event such as an album cover, photograph, poster or any other visual representation of a specific music-related media event. The image icons 345 on grouping frame 300 correspond to individual media events in the grouping displayed on the grouping frame 300, and are all associated with a common theme, such as, for example, all of the albums recorded by a band within the preselected time period.

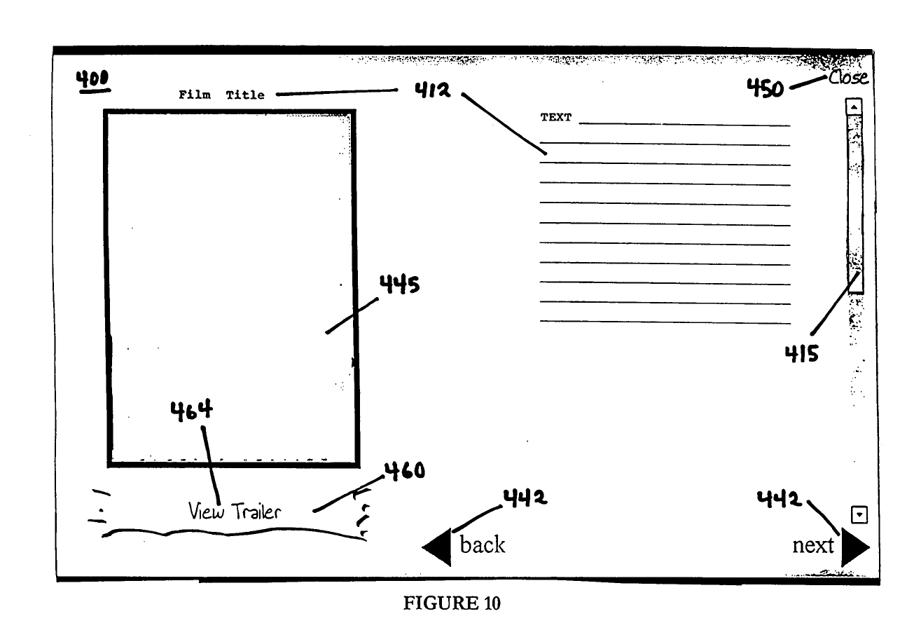

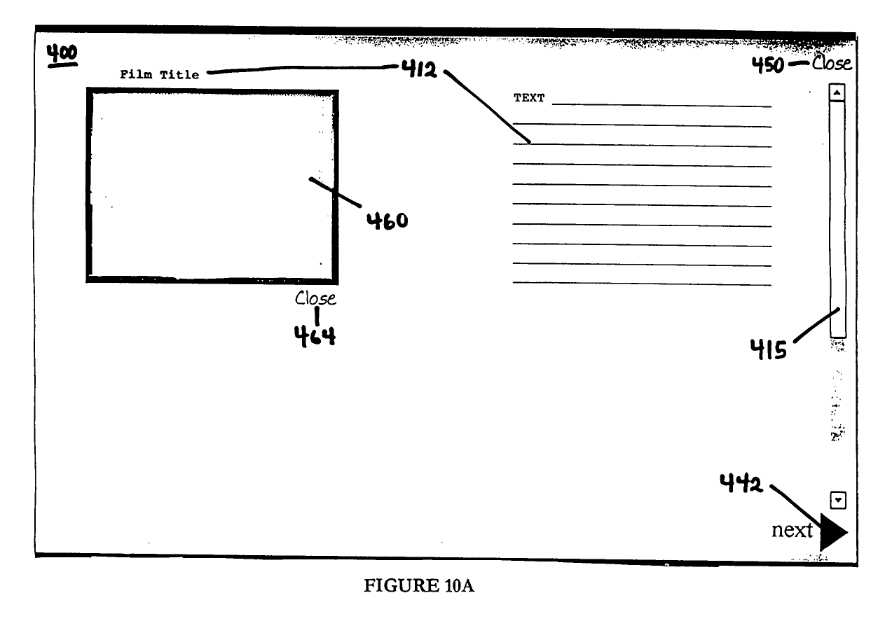

The user may exit the grouping frame by selecting close button 350, which takes the user back to the calendar frame 120 or to the closer look frame 200 from which the user accessed the grouping frame 300. Alternatively, if the user wishes to obtain further media event information about the media event he originally selected, or about any of the other media events associated with the selected event and represented by an image icon 345 on grouping frame 300, the user may select the corresponding image icon 345 on the grouping frame 300. Once an image icon 345 is selected by the user, a close-up frame 400 is presented to the user with further information about the selected media event as described in further detail below with respect to FIGS. 9 and 10.

Another embodiment of a grouping frame 300 in accordance with the present invention is shown in FIG. 7B, which shows a grouping of preselected film-related media events and corresponding contextual information, including a combination of textual material 312, images 314 and graphics 316, such as, for example, magazine or newspaper articles or film reviews, photographs of film stars and identifying information about the films.

Like the grouping frame 300 shown in FIG. 7A, the grouping frame 300 of FIG. 7B includes a plurality of image icons 345, each of which represents an individual media event. In this embodiment, such icons 345 may represent a movie cover, poster, photograph or any other visual representation of a specific film-related media event. The image icons 345 on grouping frame 300 are all associated with a common theme, such as, for example, popular films within the preselected time period.

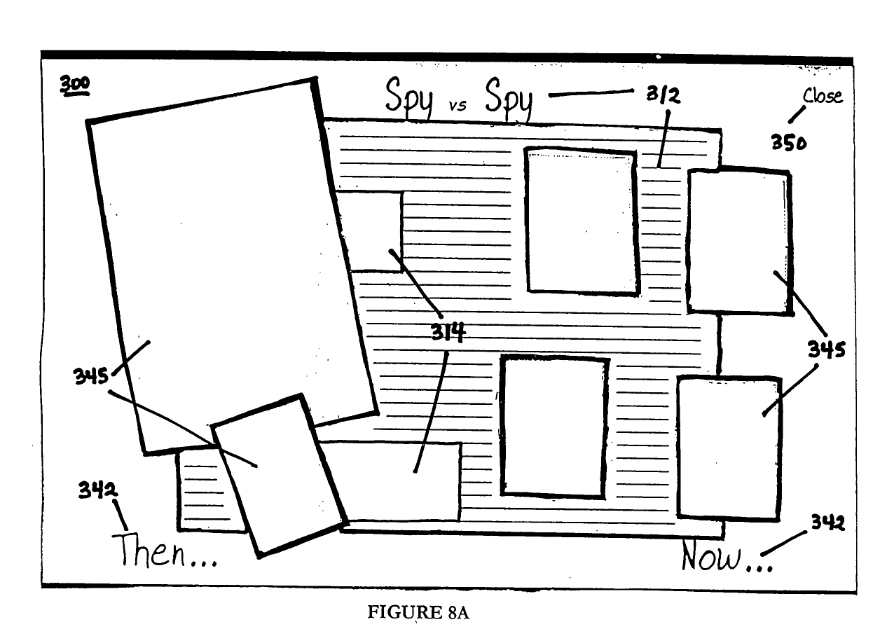

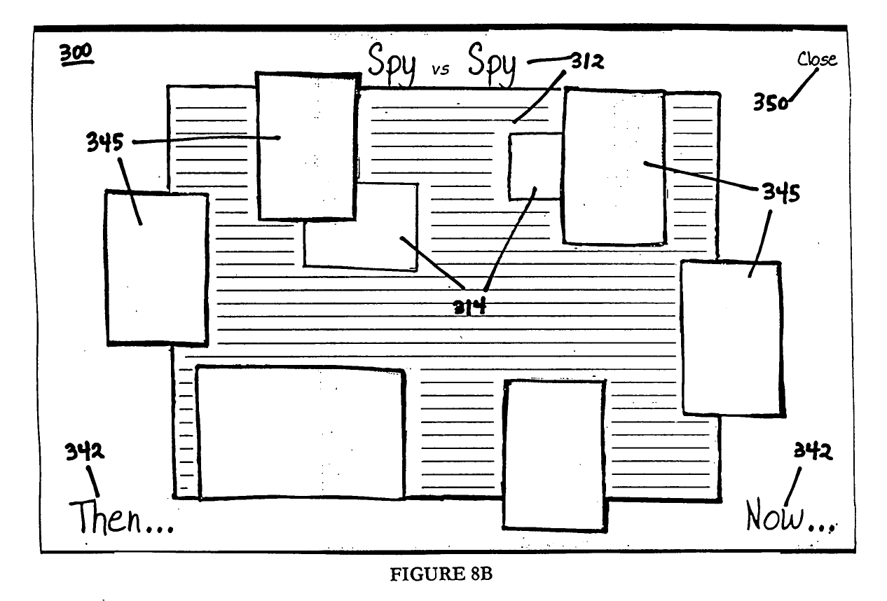

In some cases, a grouping frame 300 may enable the selection of a second or subsequent grouping of preselected media events. FIGS. 8A and 8B illustrate an embodiment of a multiple-frame grouping of film-related media events.

As in the grouping frame shown in FIG. 7B, each frame 300 of the multiple-frame grouping of FIGS. 8A and 8B comprises a plurality of preselected film-related media events and corresponding contextual information, including a combination of textual material 312, images 314 and graphics 316. Each frame also includes a plurality of image icons 345, each of which represents an individual film-related media event. In the illustrative embodiment, the first frame, shown in FIG. 8A, presents a grouping of film-related media events corresponding to the selected period of time (“Then”). The second frame, shown in FIG. 8B, presents a similar grouping of film-related media events corresponding to the present time (“Now”). The “Then” and “Now” buttons 342 on each frame 300 permit the user to select the next frame in the multiple-frame grouping and/or return to the previous frame.

Again, if the user wishes to obtain further media event information about the film-related media event he originally selected, or about any of the other media events associated with the selected event and represented by an image icon 345 on any of the grouping frames 300, the user may select the corresponding image icon 345 on the grouping frame 300. Once an image icon 345 is selected by the user, a close-up frame 400 is presented to the user with further information about the selected media event as described in further detail below with respect to FIGS. 9 and 10.

As in the single grouping frames described above with respect to FIGS. 7A and 7B, each frame 300 in the multiple-frame grouping features a close button 350 which when selected by the user, returns the user to the calendar frame 120 or to the closer look frame 200 from which the user accessed the grouping frame 300.

Close-Up Frames

Upon selection of either a button 135 on a poster 130 or an image icon 145 on the timeline 140 of the calendar frame 120, or upon selection of an image icon 145 on the closer look frame 200, if the user is not presented with a grouping frame 300 as described above, the user is presented with a close-up frame 400 that provides further information to the user regarding the selected media event.

One embodiment of a close-up frame 400 in accordance with the present invention is shown in FIG. 9. The close-up frame 400 shown in FIG. 9 includes more detailed information about a music-related media event, including textual material 412 such as editorial reviews of the selected music-related event and identifying information about the artist or band and album title. The frame 400 also includes an image 445 related to the selected media event, e.g., an album cover. In the illustrative embodiment, a scrollbar 415 is further provided to permit the user to view all of the textual material corresponding to the close-up frame 400. Back and next arrow icons 442 are also provided on the close-up frame 400 to enable the user to view additional close-up frames 400 with further detailed information such as, for example, names of band members or of persons involved in producing the selected album, or to return to close-up frames 400 previously viewed.

As noted above with respect to the audio components in the presentation of the present invention, once the user has made a selection of a specific media event, the audio component of the presentation specifically relates to the selected event. The audio component of the selected media event is provided to the user while the close-up frame 400 is displayed on the video display. More particularly, in each close-up frame 400 relating to the selected event, a media player 460 enables the user to select different segments of the audio component related to the media event. The media player 460 includes textual information 462 about the audio component, such as the title of the segment currently being played, and forward, back and pause controls 464 for enabling the user to select the previous or next segment of the audio component or to pause the player, respectively.

One close-up frame 400 in each sequence of frames for every music-related media event includes a list of segments of the audio component (i.e., a track list). As shown in FIG. 9A, the track list facilitates the user's selection of segments of the audio component relating to the selected music-related event.

The user may exit any close-up frame 400 by selecting a close button 450, which takes the user back to the calendar frame 120 or to the closer look frame 200 from which the user accessed the close-up frame 400.

Another embodiment of a close-up frame 400 in accordance with the present invention is shown in FIG. 10. The close-up frame 400 shown in FIG. 10 includes more detailed information about a film-related media event, including textual material 412 such as editorial reviews of the selected film-related event and identifying information about the film such as its title, date of release, director, and stars. The frame 400 also includes an image 445 related to the selected media event, e.g., a DVD cover. In the illustrative embodiment, a scrollbar 415 is further provided to permit the user to view all of the textual material corresponding to the close-up frame 400. Back and next arrow icons 442 are also provided on the close-up frame 400 to enable the user to view additional close-up frames 400 with further detailed information such as, for example, names of starring roles, further reviews of the film, awards won by the film and additional material available on DVD, or to return to close-up frames 400 previously viewed.

Again, as noted above with respect to the audio components in the presentation of the present invention, once the user has made a selection of a specific media event, the audio component of the presentation specifically relates to the selected event. The audio component of the selected media event is provided to the user while the close-up frame 400 is displayed on the video display. In addition, in this embodiment, in each close-up frame 400 relating to the selected event, a media player 460 includes a control 464 which enables the user to select to view a trailer of the selected film event to which the audio component relates. As shown in FIG. 10A, upon selection of the media player control 464, a trailer of the selected film event is presented to the user. During playing of the trailer, the audio component corresponds to the audio of the trailer.

The user may exit any close-up frame 400 by selecting a close button 450, which takes the user back to the calendar frame 120 or to the closer look frame 200 from which the user accessed the close-up frame 400.

As can be appreciated from the discussion above, the present invention provides a system and method for attracting the user to specific media events within preselected time periods. The system components work together to present contextual material, including audio and video components and still images of the media events, as well as textual material relating to the events, to the user. This presentation encourages the user to select a media event and obtain further information including contextual material regarding the selected media event. This, in turn, stimulates considerable interest of the user in the event and may lead to the user purchasing a product associated with the selected or a related media event.

Accordingly, it is within the contemplation of the invention that the system and method be further adapted such that the user may not only obtain information about the events, but may also purchase products related to the events, such as books, magazines, video recordings, sound recordings and the like. Thus incorporated into the system may be a conventional product purchasing system such as secure purchasing on the Internet, either directly or through online vendors, or via a broadband cable system.

In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

What is claimed is:

1. A method of providing information to a user comprising the steps of:
providing the user with media event information for specific media events all related to a preselected time period;
enabling the user to select the media event information of a given one of said specific media events; and
providing the user with further information related to the selected media event, said method being implemented using:
a storage unit storing the media event information and further information;
an interactive interface for use by the user to access said storage unit for obtaining said media event information and further information and provide said media event information and further information to said user; and
a processing unit cooperating with said interactive interface and said storage unit to enable said accessing and obtaining of said media event information and further information from said storage unit by said interactive interface and the providing of said media event information and said further information by said interactive interface.

2. The method according to claim 1, where each of said media events comprises one or more of audio, visual and textual components.

3. The method according to claim 2, wherein said media events include one or more of a sound recording, a video-sound recording and written text material.

4. The method according to claim 3, wherein said written text material comprises a book.

5. The method according to claim 3 wherein said media event information comprises an image relating to a media event.

6. The method according to claim 3, wherein said step of providing to the user media event information for specific media events includes presenting sub-periods of said preselected time period and presenting the media event information for certain media events in areas of said sub-periods.

7. The method according to claim 6, wherein said sub-periods are individual calendar month periods in said preselected time period and said areas are date areas in said month periods.

8. The method of claim 7, wherein the date area in which the media event information for a particular media event is presented is related to the particular media event.

9. The method of claim 7, wherein the step of providing to the user media event information for specific media events further includes presenting media event information for further certain of said specific media events exterior of the presentation of said calendar month periods.

10. The method of claim 9, wherein the presentation of said calendar months is a horizontal presentation and the presentation of the media event information for the further certain specific media events is a horizontal presentation above the horizontal presentation of said calendar months.

11. The method of claim 10, wherein the presentation of said calendar months includes presenting a number of said months at one time and enabling the user to scroll the presentation at least one of backward and forward in time to obtain a presentation of one or more of the other months in said preselected time period until all the months in said preselected time period have been presented.

12. The method of claim 11, wherein the presentation of said calendar months includes: enabling the user to select preselected groups of said calendar months; and presenting in enlarged format a selected one of said preselected groups of said calendar months to said user upon selection by the user.

13. The method of claim 12 wherein: said preselected groups of months include a group corresponding to the calendar months of winter, a group corresponding to the calendar months of spring, a group corresponding to the calendar months of summer, and a group corresponding to the calendar months of fall.

14. The method of claim 12, further comprising: providing the user with introductory contextual material for the preselected time period; and enabling the user to select said step of being provided with media event information for specific media events all related to the preselected time period.

15. The method according to claim 14, wherein said introductory contextual material includes one or more of audio, visual and textual contextual material.

16. The method according to claim 15, wherein said step of providing the user with further information related to the selected media event comprises the sub-steps of: enabling the user to select yet more information; and providing the user with the more information once selected; and repeating said sub-steps one or more times.

17. The method of claim 16, wherein in one or more of the steps of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

18. The method of claim 17, further comprising:
enabling a user to purchase a product related to a selected media event.

19. The method of claim 17, wherein the selected media event is a sound recording and wherein one or more of the steps of providing the user with further information and providing the user with more information includes providing at least a segment of said sound recording, enabling the user to select another segment of said sound recording, and providing said other segment.

20. The method of claim 17, wherein the selected media event is a video-sound recording, and wherein one or more of the steps of providing the user with further information and providing the user with more information includes providing the user with video and sounds from at least a segment of said video-sound recording.

21. The method of claim 17, wherein the selected media event is written textual material in book form.

22. The method of claim 17, wherein each of said preselected time periods in said plurality of preselected time periods is one year.

23. The method of claim 22, wherein the plurality of preselected time periods include the time periods 1964, 1965, 1966, 1967, 1968 and 1969.

24. The method of claim 3, further comprising;
during said step of providing the user with media event information for specific media events all related to a preselected time period, simultaneously providing the user with successive media events in the form of sounds of at least segments of successively presented preselected sound recordings related to the preselected time period.

25. The method of claim 24, wherein said step of simultaneously providing includes one or more of the following: first enabling the user to stop said simultaneously providing; and second enabling the user to be provided with additional information of the sound recording the sounds of which are currently being provided.

26. The method of claim 25, wherein the step of second enabling the user to be provided with additional information further includes one or more of the following: enabling the user to select songs on said sound recording and providing sounds of said selected song; enabling the user to be provided with images related to the sound recording; enabling the user to be provided with textual material related to the sound recording; and enabling the user to be provided with contextual material including audio, visual and textual contextual material related to the sound recording.

27. The method according to claim 3, wherein said step of providing to the user media event information for specific media events includes presenting sub-periods of said preselected time period and presenting the media event information for certain media events in areas of said sub-periods.

28. The method of claim 27, further comprising:
enabling a user to purchase a product related to a selected media event.

29. The method according to claim 27, wherein said sub-periods are individual calendar month periods in said preselected time period and said areas are date areas in said month periods.

30. The method of claim 29, wherein the date area in which the media event information for a particular event is presented is related to the particular media event.

31. The method of claim 30, wherein the step of providing to the user media event information for specific media events further includes presenting media event information for further certain of said specific media events exterior of the presentation of said calendar month periods.

32. The method of claim 31, wherein the presentation of said calendar months is a horizontal presentation and the presentation of the media event information for the further certain specific media events is a horizontal presentation above the horizontal presentation of said calendar months.

33. The method of claim 32, wherein the presentation of said calendar months includes presenting a number of said months at one time and enabling the user to scroll the presentation at least one of backward and forward in time to obtain a presentation of one or more of the other months in said preselected time period until all the months in said preselected time period have been presented.

34. The method of claim 33, wherein the presentation of said calendar months includes: enabling the user to select preselected groups of said calendar months; and presenting in enlarged format a selected one of said preselected groups of said calendar months to said user upon selection by the user.

35. The method of claim 34 wherein: said preselected groups of months include a group corresponding to the calendar months of winter, a group corresponding to the calendar months of spring, a group corresponding to the calendar months of summer, and a group corresponding to the calendar months of fall.

36. The method of claim 27, further comprising: providing the user with introductory contextual material for the preselected time period; and enabling the user to select said step of being provided with media event information for specific media events all related to the preselected time period.

37. The method according to claim 36, wherein said introductory contextual material includes one or more of audio, visual and textual contextual material.

38. The method according to claim 37, wherein said step of providing the user with further information related to the selected media event comprises the sub-steps of: enabling the user to select yet more information; providing the user with the more information once selected; and repeating said sub-steps one or more times.

39. The method of claim 38, wherein in one or more of the steps of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

40. The method of claim 39, further comprising:
enabling a user to purchase a product related to a selected media event.

41. The method of claim 39, further comprising;
during at least one or more of providing the user with introductory contextual material and providing the user with media event information for specific media events all related to a preselected time period, simultaneously providing the user with successive media events in the form of sounds of at least segments of successively presented songs of sound recordings related to the preselected time period.

42. The method of claim 41, wherein said step of simultaneously providing includes one or more of the following: first enabling the user to stop said simultaneously providing; and second enabling the user to be provided with additional information of the sound recording the sounds of which are currently being provided.

43. The method of claim 36, further comprising;
during said step of providing the user with media event information for specific media events all related to a preselected time period, simultaneously providing the user with successive media events in the form of sounds of at least segments of successively presented songs of sound recordings related to the preselected time period.

44. The method of claim 43, wherein said step of simultaneously providing includes one or more of the following: first enabling the user to stop said simultaneously providing; second enabling the user to be provided with additional information of the sound recording the sounds of which are currently being provided; and presenting first and second images the selection of which by said user brings into effect said first and second enabling steps, respectively, included in said simultaneously providing step.

45. The method of claim 27, further comprising:
during said step of providing the user with media event information for specific media events all related to a preselected time period, simultaneously providing the user with successive media events in the form of sounds of at least segments of successively presented songs of sound recordings related to the preselected time period.

46. The method of claim 3, further comprising: providing the user with introductory contextual material for the preselected time period; and enabling the user to select said step of being provided with media event information for specific media events all related to the preselected time period.

47. The method according to claim 46, wherein said contextual material includes one or more of audio, visual and textual contextual material.

48. The method according to claim 47, wherein said step of providing the user with further information related to the selected media event comprises the sub-steps of: enabling the user to select yet more information; providing the user with the more information once selected; and repeating said sub-steps one or more times.

49. The method of claim 48, wherein in one or more of the steps of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

50. The method of claim 1, further comprising: providing the user with introductory contextual material for the preselected time period; and enabling the user to select said step of being provided with media event information for specific media events all related to the preselected time period.

51. The method according to claim 50, wherein said step of providing the user with further information related to the selected media event comprises the sub-steps of: enabling the user to select yet more information; providing the user with the more information once selected; and repeating said sub-steps one or more times.

52. The method of claim 51, wherein in one or more of the steps of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

53. The method according to claim 1, wherein said step of providing to the user media event information for specific media events includes presenting sub-periods of said preselected time period and presenting the media event information for certain media events in areas of said sub-regions.

54. The method according to claim 53, wherein said sub-periods are individual calendar month periods in said preselected time period and said areas are date areas in said month periods.

55. The method of claim 54, wherein the date area in which the media event information for a particular media event is presented is related to the particular media event.

56. The method of claim 1, wherein said storage unit, interactive interface and processing unit are incorporated into a common station.

57. The method of claim 56 wherein said station is a stand alone station.

58. The method of claim 1, wherein said storage unit, interactive interface and processing unit are part of a broadband television system.

59. The method of claim 58, wherein broadband television system is a cable television system.

60. The method of claim 58, wherein said interactive interface is part of a television.

61. The method of claim 58, further comprising:
enabling a user to purchase a product related to a media event.

62. The method of claim 1, wherein said storage unit, interactive interface and processing unit are connected to the Internet.

63. The method of claim 62, further comprising:
enabling a user to purchase a product related to a media event.

64. A system for providing information to a user comprising:
a storage unit storing the media event information and further information;
an interactive interface for use by the user to access said storage unit for obtaining said media event information and further information and present said media event information and further information to said user; and
a processing unit cooperating with said interactive interface and said storage unit to enable said accessing and obtaining of said media event information and further information from said storage unit by said interactive interface and the providing said media event information and said further information by said interactive interface;
the system being adapted to:
provide the user with media event information for specific media events all related to a preselected time period;
enable the user to select the media event information of a given one of said specific media events; and
provide the user with further information related to the selected media event.

65. The system according to claim 64, where each of said media events comprises one or more of audio, visual and textual components.

66. The system according to claim 65, wherein said media events include one or more of a sound recording, a video-sound recording and written text material.

67. The system according to claim 66, wherein said written text material includes written text material in book form.

68. The system according to claim 66 wherein said media event information comprises an image relating to a media event.

69. The system according to claim 66, wherein the providing to the user media event information for specific media events includes presenting sub-periods of said preselected time period and presenting the media event information for certain media events in areas of said sub-periods.

70. The system according to claim 69, wherein said sub-periods are individual calendar month periods in said preselected time period and said areas are date areas in said month periods.

71. The system of claim 70, wherein the date area in which the media event information for a particular media event is presented is related to the particular media event.

72. The system of claim 71, wherein the providing to the user media event information for specific media events further includes presenting media event information for further certain of said specific media events exterior of the presentation of said calendar month periods.

73. The system of claim 72, wherein the presentation of said calendar months is a horizontal presentation and the presentation of the media event information for the further certain specific media events is a horizontal presentation above the horizontal presentation of said calendar months.

74. The system of claim 73, wherein the presentation of said calendar months includes presenting a number of said months at one time and enabling the user to scroll the presentation at least one of backward and forward in time to obtain a presentation of one or more of the other months in said preselected time period until all the months in said preselected time period have been presented.

75. The system of claim 74, wherein the presentation of said calendar months includes: enabling the user to select preselected groups of said calendar months; and presenting a selected one of said preselected groups of said calendar months to said user upon selection by the user.

76. The system of claim 75 wherein: said preselected groups of months include a group corresponding to the calendar months of winter, a group corresponding to the calendar months of spring, a group corresponding to the calendar months of summer; and a group corresponding to the calendar months of fall.

77. The system of claim 75, further adapted to: provide the user with introductory contextual material for the preselected time period; and enable the user to select said being provided with media event information for specific media events all related to the preselected time period.

78. The system of claim 77, wherein said introductory contextual material includes one or more of audio, visual and textual contextual material.

79. The system of claim 78, wherein the providing the user with further information related to the selected media event comprises: enabling the user to select yet more information; and providing the user with the more information once selected; and carrying out the previous two procedures one or more times.

80. The system of claim 79, wherein in one or more of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

81. The system of claim 80 further adapted to enable a user to purchase a product related to a media event.

82. The system of claim 80, wherein the selected media event is a sound recording and wherein one or more providing the user with further information and providing the user with more information includes providing sounds of at least a segment of a song on said sound recording, enabling the user to select another song on said sound recording, and providing sounds of at least a segment of said other song.

83. The system of claim 80, wherein the selected media event is a video-sound recording, and wherein in one or more of providing the user with further information and providing the user with more information includes providing the user with video and sounds from at least a segment of said video-sound recording.

84. The system of claim 80, wherein the selected media event is written textual material in book form.

85. The system of claim 80, wherein each of said preselected time periods in said plurality of preselected time periods is one year.

86. The system of claim 80, wherein the plurality of preselected time periods include the time periods 1964, 1965, 1966, 1967, 1968 and 1969.

87. The system of claim 66, further adapted to:
during providing the user with media event information for specific media events all related to a preselected time period, simultaneously providing the user with successive media events in the form of sounds of at least segments of successively presented songs of sound recordings related to the preselected time period.

88. The system of claim 87, wherein said simultaneously providing includes one or more of the following: first enabling the user to stop said simultaneously providing; and second enabling the user to be provided with additional information of the sound recording whose sounds of a song are currently being provided.

89. The system of claim 88, wherein said second enabling the user to be provided with additional information further includes one or more of the following: enabling the user to be provided with images related to the sound recording; enabling the user to be provided with textual material related to the sound recording; and enabling the user to be provided with contextual material including one or more of audio, visual and textual contextual material related to the sound recording.

90. The system of claim 66, wherein said providing to the user media event information for specific media events includes presenting sub-periods of said preselected time period and presenting the media event information for certain media events in areas of said sub-periods.

91. The system of claim 90 further adapted to enable the user to purchase a product related to a media event.

92. The system of claim 90, wherein said sub-periods are individual calendar month periods in said preselected time period and said areas are date areas in said month periods.

93. The system of claim 92, wherein the date area in which the media event information for a particular media event is presented is related to the particular media event.

94. The system of claim 93, wherein the providing to the user media event information for specific media events further includes presenting media event information for further certain of said specific events exterior of the presentation of said calendar month periods.

95. The system of claim 94, wherein the presentation of said calendar months is a horizontal presentation and the presentation of the media event information for the further certain of said specific media events is a horizontal presentation above the horizontal presentation of said calendar months.

96. The system of claim 95, wherein the presentation of said calendar months includes presenting a number of said months at one time and enabling the user to scroll the presentation at least one of backward and forward in time to obtain a presentation of one or more of the other months in said preselected time period until all the months in said preselected time period have been presented.

97. The system of claim 96, wherein the presentation of said calendar months includes: enabling the user to select preselected groups of said calendar months; and presenting a selected one of said preselected groups of said calendar months in enlarged format to said user upon selection by the user.

98. The system of claim 97 wherein: said preselected groups of months include a group corresponding to the calendar months of winter, a group corresponding to the calendar months of spring, a group corresponding to the calendar months of summer; and a group corresponding to the calendar months of fall.

99. The system of claim 90, further adapted to: provide the user with introductory contextual material for the preselected time period; and enable the user to select being provided with media event information for specific media events all related to the preselected time period.

100. The system of claim 99, wherein said introductory contextual material includes one or more of audio, visual and textual material.

101. The system of claim 100, wherein said providing the user with further information related to the selected media event comprises: enabling the user to select yet more information; and providing the user with the more information once selected; and carrying out the previous two procedures one or more times.

102. The system of claim 101, wherein in one or more of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

103. The system of claim 102, further adapted to enable the user to purchase a product related to a media event.

104. The system of claim 102, further adapted to:
during at least one or more of providing the user with introductory contextual material and providing the user with media event information for specific media events all related to a preselected time period, simultaneously providing the user with successive media events in the form of sounds of at least segments of successively presented songs of sound recordings related to the preselected time period.

105. The system of claim 104, wherein said simultaneously providing includes one or more of the following: first enabling the user to stop said simultaneously providing; and second enabling the user to be provided with additional information of the sound recording the sounds of which are currently being provided.

106. The system of claim 99, further adapted to;
during said providing the user with media event information for specific media events all related to a preselected time period, simultaneously providing the user with successive media events in the form of sounds of at least segments of successively presented songs of sound recordings related to the preselected time period.

107. The system 106, wherein said simultaneously providing includes one or more of the following: first enabling the user to stop said simultaneously providing; second enabling the user to be provided with additional information of the sound recording the sounds of which are currently being provided; and presenting first and second images the selection of which by said user brings into effect said first and second enabling, respectively, included in said simultaneously providing.

108. The system of claim 90, further adapted to:
during said providing the user with media event information for specific media events all related to a preselected time period, simultaneously providing the user with successive media events in the form of sounds of at least segments of successively presented songs of sound recordings related to the preselected time period.

109. The system of claim 66, further adapted to provide the user with introductory contextual material for the preselected time period and enable the user to select being provided with media event information for specific media events all related to the preselected time period.

110. The system of claim 109, wherein said contextual material includes one or more of audio, visual and textual contextual material.

111. The system of claim 110, wherein said providing the user with further information related to the selected media event comprises: enabling the user to select yet more information; providing the user with the more information once selected; and carrying out the previous two procedures one or more times.

112. The method of claim 111, wherein in one or more of the providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

113. The system of claim 64, further adapted to: provide the user with introductory contextual material for the preselected time period; and enable the user to select being provided with media event information for specific media events all related to the preselected time period.

114. The system of claim 113, wherein said providing the user with further information related to the selected media event comprises: enabling the user to select yet more information; providing the user with the more information once selected; and carrying out the previous two procedures one or more times.

115. The system of claim 114, wherein in one or more of providing the user with further information and providing the user with more information, one or more of the following is provided: images related to the selected media event; textual material related to the selected media event; contextual material including one or more of audio, visual and textual contextual material related to the selected media event; media event information of a grouping of media events related to the selected media event; and media event information of a first grouping of media events occurring at an earlier time and a second grouping of media events occurring at a later time related to each other and to the selected media event.

116. The system of claim 64, wherein said providing to the user media event information for specific media events includes presenting sub-periods of said preselected time period and presenting the media event information for certain media events in areas of said sub-periods.

117. The system of claim 116, wherein said sub-periods are individual calendar month periods in said preselected time period and said areas are date areas in said month periods.

118. The system of claim 117, wherein the date area in which the media event information for a particular media event is presented is related to the particular media event.

119. The system of claim 64, wherein said storage unit, interactive interface and processing unit are incorporated into a common station.

120. The system of claim 119, wherein said station is a stand alone station.

121. The system of claim 64, wherein said storage unit, interactive interface and processing unit are part of a broadband television system.

122. The system of claim 121, wherein broadband television system is a cable television system.

123. The system of claim 122, wherein said interactive interface is part of a television.

124. The system of claim 121, further adapted to:
enable a user to purchase a product related to a media event.

125. The system of claim 64, wherein said storage unit, interactive interface and processing unit are connected to the Internet.

126. The system of claim 64, further adapted to:
enable a user to purchase a product related to a media event.

127. A computer-readable storage medium storing a program that implements the method of providing information to a user according to claim 1.

128. A computer-readable storage medium having stored therein a program for causing the execution, by a computer, of the respective means included in the system for providing information to a user according to claim 64.

129. A computer-readable storage medium storing a program that implements the method of providing information to a user according to claim 17.

130. A computer-readable storage medium having stored therein a program for causing the execution, by a computer, of the respective means included in the system for providing information to a user according to claim 80.
